(19) United States
(12) Patent Application Publication
(10) Pub. No.: US 2017/0017923 A1
(43) Pub. Date: Jan. 19, 2017

(54) INFRASTRUCTURAL METHODOLOGY FOR COMMERCIALIZING A MARKET UNIT

(71) Applicant: STRATHSPEY CROWN HOLDINGS, LLC, Newport Beach, CA (US)

(72) Inventors: Robert Edward Grant, Laguna Beach, CA (US); Benjamin Wade Judge, Irvine, CA (US); Jennifer Mons, Mission Viejo, CA (US)

(21) Appl. No.: 14/802,877

(22) Filed: Jul. 17, 2015

(51) Int. Cl. G06Q 10/10; G06Q 30/02

(52) U.S. Cl. CPC G06Q 10/101; G06Q 30/0217

(57) ABSTRACT

A system incorporates an infrastructural method for commercializing a market unit which requires refining the initial efforts of an external entity in a commercial venture by a process of elimination. In detail, the external entity conceives a plan for possible implementation into a work product and submits the plan to an internal entity. The internal entity may then select the plan after conception, and subsequently evaluate the work product after its implementation before further development of the market unit. Credits are appropriately issued to the internal entity for selecting the plans and for evaluating the work products. Credits are also issued to the external entity for selection of its plan for implementation and for a successful evaluation of the resultant work product for development as a market unit. Credits can then be used as value for exchange with any external entity participating in the system.

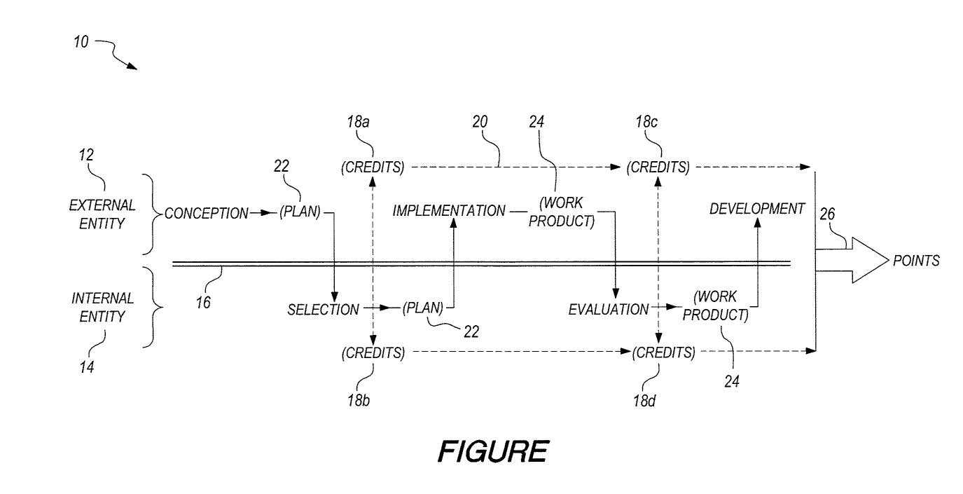

### FIELD OF THE INVENTION

The present invention pertains generally to systems which incorporate infrastructural methods for commercializing goods and services (i.e. market units). More particularly, the present invention pertains to methods for commercializing market units which require interactive participation by different legal entities, having different business perspectives. The present invention is particularly, but not exclusively, useful for methods which provide participants with incentives for their respective contributions in an interactive process between a business entity which is involved with objective considerations for a market unit (e.g. research, development and manufacturability), and another, separate business entity which is concerned primarily with subjective considerations for the market unit (e.g. functionality, price considerations and marketability).

### BACKGROUND OF THE INVENTION

As is well-known in the business world, the development and commercialization of goods and services is always time consuming and exceptionally expensive. In almost every instance it happens that as the complexity of the goods and/or services increases, the time and expense for their development and commercialization will also increase; most likely this will be exponentially. A major contributing factor to this circumstance is that, in each case, it is typically necessary to coordinate several diverse personal skill-sets (i.e. objective and/or subjective capabilities) with different tasks.

Many individual inventors and most small business enterprises are innovative and are aware of the many challenges and pitfalls that are necessarily encountered during the commercialization of goods (i.e. products) and services. They generally understand the risks that are involved. Nevertheless, although they are willing to take these risks, they still prefer there be some safeguards, and oversight mechanisms that will help minimize adverse effects should the venture somehow fail.

With the above in mind, it is an object of the present invention to provide an infrastructural method that incorporates the wherewithal from different sources to proceed with the commercialization of a new market unit (goods or services), while at the same time providing an additional incentive to participate in the process. Another object of the present invention is to provide an infrastructural method for commercializing a market unit which is easy to set up, is simple to implement, and is cost effective.

### SUMMARY OF THE INVENTION

In accordance with the present invention a system which incorporates an infrastructural methodology for commercializing a market unit (i.e. product/service) is presented. More specifically, the methodology of the present invention requires the cooperative efforts of three separate entities. These entities are: 1) a product-oriented entity which initially conceives the market unit, plans for its production, and may eventually participate in its development; 2) a market-oriented entity which selects and evaluates the market unit for development; and 3) an oversight entity which issues appropriate credits to the product-oriented entity and to the market-oriented entity when respective production goals have been achieved.

For purposes of the present invention, a product-oriented entity may sometimes be referred to as an “external” entity or an “objective” entity. In any case the product-oriented entity will comprise the inventors, authors, workers, engineers and scientists who plan for and develop the market unit (i.e. work product). On the other hand, a market-oriented entity may sometimes be referred to as an “internal” entity or a “subjective” entity. It essentially comprises a panel of experts, who are collectively skilled in commercial and technical matters pertinent to the market unit. As the name implies, the oversight entity controls the cooperative interaction between the product-oriented entity and the market-oriented entity. It also monitors the progress of the commercialization process by providing appropriate incentives.

As a methodology, the present invention requires the sequential progress of certain procedural steps, and the successful accomplishment of predetermined goals. In detail, an external (product-oriented) entity conceives of a plan (e.g. an invention disclosure) for a proposed market unit. Following a conception of the market unit, the external entity prepares the plan and submits it to the internal entity for review. The internal entity will then reject or accept the plan for further consideration. If the plan is accepted (i.e. selected), and the commercialization effort is to be continued, the plan is sent back to the external entity for implementation. Also, at this point in the process, an oversight entity will award credits to the external entity for having submitted a plan which was accepted, and the oversight entity will award credits to the internal entity for its work in accepting or rejecting the plan. Once a plan from the external entity has been selected by the internal entity, the external entity is instructed to implement the plan. At this point, the external entity can proceed to create a work product, if it is inclined to do so. Otherwise the internal entity may opt to use another external entity. In any event, documentation regarding the work product that is sufficient to establish a “proof of concept” for the market unit can be sent to the internal entity for evaluation. Again, a decision is made by the internal entity concerning whether the commercialization process should be continued. After an evaluation of the work product by the internal entity, a decision is made by the internal entity concerning whether to continue the commercialization process. If so, the external entity is instructed to proceed with the development of the work product for commercialization as the market unit. At this point, the oversight entity will again issue credits to the external entity. In this instance credits are issued for the implementation of a work product that has been determined to be worthy of further commercial development. Additionally, the internal entity will receive credits for its work in evaluating the work product for commercialization.

As intended for the present invention, the actual manufacture or publication of a market unit can be done by anyone using whatever methods are required. The implication given above, however, is that the external, product-oriented entity may continue with the manufacture/publication of the market entity. In any event, when credits have been issued, they can then be used by the recipient as value for any purpose in an exchange with any external entity participating in the system.

### BRIEF DESCRIPTION OF THE DRAWINGS

The novel features of this invention, as well as the invention itself, both as to its structure and its operation, will be best understood from the accompanying drawing, taken in conjunction with the accompanying description, in which similar reference characters refer to similar parts, and in which:

The FIGURE is a functional presentation of sequential tasks performed by external, internal and oversight entities to earn credits for their participation in a development process for the commercialization of a market unit.

### DESCRIPTION OF THE PREFERRED EMBODIMENTS

Referring to the FIGURE, a functional presentation of a system which incorporates infrastructural methods for the purpose of commercializing goods and services is shown and is generally designated 10. As shown, the Figure indicates that the process for commercializing goods and services in accordance with the present invention relies on a cooperative interaction between an external entity 12 and an internal entity 14. Further, the Figure indicates that the external entity 12 is intended to perform tasks which are presented above the double line 16, while the internal entity 14 is intended to perform tasks which are presented below the double line 16. Not shown in the FIGURE is an oversight entity which essentially monitors and controls the sequence of activities (tasks) which are respectively performed by the external entity 12 and the internal entity 14. In particular, the oversight entity provides its control over the system 10 by issuing credits 18 (exemplified by credits 18a, 18b, 18c and 18d) at different stages in the methodology of the present invention as indicated by the dashed lines 20.

With specific regard to the activities of the external entity 12 of the system 10, it is to be first appreciated that the external entity 12 is essentially product-oriented. Stated differently, the external entity 12 has an objective, pragmatic perception of its contribution for the system 10. In general, the external entity 12 is involved with the objective considerations pertaining to the commercialization of goods and services (e.g. research, development and manufacturability). Moreover, it is the external entity 12 that provides the conception of the market unit (not shown) that is to be commercialized. The FIGURE shows that this conception will first be presented into the system 10 as a plan 22. As envisioned for the present invention, the plan 22 will typically be something akin to an invention disclosure, a project proposal, or a business plan.

After conception, the plan 22 is submitted across the double line 16 to the internal entity 14 where it is reviewed and examined for possible acceptance. With specific regard to the activities of the internal entity 14, the internal entity 14 is essentially market-oriented. Stated differently, the internal entity 14 has a more subjective perception of its role for the system 10. More specifically, the internal entity 14 is primarily concerned with subjective consideration for the market unit (e.g. functionality, price considerations and marketability). Typically, the internal entity 14 will be comprised of a panel of experts who are chosen for their skills in commercial and technical matters that are pertinent to the market unit. From this perspective, the internal entity 14 will select plans 22 that deserve further commercial consideration. In essence, selections are made by the internal entity 14 using a process of elimination. The selected plans 22 are then returned across the double line 16 to the external entity 12 for implementation.

At this point it is to be noted that the oversight entity will issue credits 18 to both the external entity 12 and to the internal entity 14. Specifically, credits 18 are issued to the external entity 12 for presenting a plan 22 that has been selected for further consideration. And, credits 18 are issued to the internal entity 14 for its work in selecting the plan 22.

Upon receipt of a selected plan 22, the external entity 12 then works on an implementation of the plan 22. As envisioned for the present invention, this implementation will result in a work product 24 (i.e. a prototype) such as a draft of a proposed publication, documentation for a process, or a working model of a device that can be used to establish a “proof of concept.” In the event, when the work product 24 has been completed, it is passed back across the double line 16 to the internal entity 14 for evaluation.

Evaluation of a work product 24 is accomplished by the internal entity 14 with a view focused on market acceptance. Then, if there is a favorable evaluation of the work product 24, the internal entity 14 will send instructions to the external entity 12 to proceed with the publication or the manufacturing of a market unit.

At this point it is again noted that the oversight entity will issue credits 18 to both the external entity 12 and to the internal entity 14. Specifically, this time, credits 18 are issued to the external entity 12 for implementing the plan 22 in a manner that receives a favorable evaluation from the external entity 12. Again, credits 18 are issued to the internal entity 14. This time, however, the credits 18 are issued to the internal entity 14 for its work in evaluating the work product 24.

By way of review, within the infrastructural methodology employed by the present invention, a plan 22 is morphed into a work product 24 which is eventually commercialized as a market unit. Also, it is to be noted that the credits 18 which are earned by the external entity 12 and the internal entity 14 can be redeemed as points 26 and then used by the recipient as value for any purpose in an exchange with any external entity 12 participating in the system 10.

While the particular Infrastructural Methodology as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An infrastructural method for commercializing a market unit which comprises the steps of:
conceiving a plurality of plans for a respective plurality of proposed market units, wherein the conceiving step is performed by an external entity;
selecting at least one of the plans for implementation, wherein the selecting step is accomplished by an internal entity;
implementing the plan selected by the internal entity to create a work product, wherein the implementing step is accomplished by the external entity;
evaluating the work product, wherein the evaluating step is accomplished by the internal entity;
developing the work product into the market unit;
issuing credits to the external entity for conception of the selected plan and for implementation of the work product; and
issuing credits to the internal entity for selecting plans and for evaluating work products.

2. The method as recited in claim 1 wherein the external entity includes the inventors and the authors of each plan conceived during the conceiving step.

3. The method as recited in claim 2 wherein credits issued to the external entity are based on the content of a contribution made respectively during the conceiving step and during the implementing step, and are awarded respectively upon selection of the plan for consideration in the implementing step and favorable evaluation of the work product for development.

4. The method as recited in claim 1 wherein the internal entity is a panel of experts, and wherein the experts are collectively skilled in commercial and technical matters pertinent to the market unit.

5. The method as recited in claim 4 wherein credits issued to the internal entity are based on an evaluated rating for each participant expert and the content of their respective contribution during the selecting step and during the evaluating step, and wherein the issued credits are awarded individually upon a completion of the selecting step and a completion of the evaluating step.

6. The method as recited in claim 1 wherein the market unit is selected from the group consisting of a process, machine, manufacture, composition of matter, and improvements thereof.

7. The method as recited in claim 1 further comprising the step of converting credits into exchangeable value points, wherein the value points are useable for remuneration from commercial profit generated by the market unit.

8. The method as recited in claim 1 further comprising the steps of:
submitting the plan from the external entity to the internal entity after the conceiving step;
returning a selected plan from the internal entity to the external entity for initiation of the implementing step;
submitting work product documentation from the external entity to the internal entity, wherein the work product documentation is based on the plan; and
forwarding documentation for an evaluated work product to a third entity for development of the market unit.

9. The method as recited in claim 8 wherein the third entity and the external entity are substantially the same.

10. The method as recited in claim 1 wherein the external entity is legal and is selected from the group consisting of an individual, a corporation, a consortium, a partnership, and groups thereof.

11. An infrastructural method for commercializing a market unit which comprises the steps of:
refining an external entity by a process of elimination, wherein the external entity is identified by the conception of a plan for selected consideration and possible implementation into a work product;
employing an internal entity for selection of the plan and evaluation of the work product for development of the market unit;
issuing credits to the internal entity for selecting the plans and evaluating the work products; and
issuing credits to the external entity for a selection of its plan for implementation and for a successful evaluation of its work product for development as a market unit.

12. The method as recited in claim 11 wherein the external entity includes the inventors and the authors of each plan conceived during the conceiving step.

13. The method as recited in claim 12 wherein credits issued to the external entity are based on the content of a contribution made respectively during conception of the plan and during the creation of the work product, and are awarded respectively upon selection of the plan for consideration of implementation and favorable evaluation of the work product for development.

14. The method as recited in claim 11 wherein the internal entity is a panel of experts, and wherein the experts are collectively skilled in commercial and technical matters pertinent to the market unit.

15. The method as recited in claim 14 wherein credits issued to the internal entity are based on an evaluated rating for each participant expert and the content of their respective contribution during the selecting step and during the evaluating step, and wherein the issued credits are awarded individually upon a completion of the selecting step and a completion of the evaluating step.

16. The method as recited in claim 11 wherein the market unit is selected from the group consisting of a process, a machine, a manufacture, a composition of matter, and improvements thereof.

17. The method as recited in claim 11 further comprising the step of converting credits into exchangeable value points, wherein the value points are useable for remuneration from commercial profit generated by the market unit.

18. An infrastructure for commercializing a market unit which comprises:
a plurality of product-oriented entities, wherein each product-oriented entity conceives a plan for at least one proposed market unit, including an implementation of the plan to create a work product;
a market-oriented entity for selecting a plan for implementation, and for evaluating a work product for further development of the work product into the market unit; and
an oversight entity for issuing credits to product-oriented entities for conception of the plan when the plan is selected, and for implementation of the work product after the work product has been evaluated, and also for issuing credits to the market-oriented entity for selecting plans and for evaluating work products.

19. The infrastructure as recited in claim 18 wherein the product-oriented entities include inventors and authors of each selected plan, and workers, engineers and scientists implementing the plan to create the work product.

20. The infrastructure as recited in claim 18 wherein the market-oriented entity is a panel of experts, and wherein the experts are collectively skilled in commercial and technical matters pertinent to the market unit.
